(19) United States
(12) Patent Application Publication
(10) Pub. No.: US 2007/0058085 A1
(43) Pub. Date: Mar. 15, 2007

(54) Interactive remote control for toddlers

(76) Inventor: Ari Eliaz, Tel Aviv (IL)

Correspondence Address: MERCHANT & GOULD PC, P.O. BOX 2903, MINNEAPOLIS, MN, 55402-0903, US

(21) Appl. No.: 11/516,704

(22) Filed: Sep. 7, 2006

Related U.S. Application Data
(60) Provisional application No. 60/715,183, filed on Sep. 9, 2005.

(51) Int. Cl. H04N 5/44

(52) U.S. Cl. 348/734

(57) ABSTRACT

A child's remote control for use with a television (TV) or interactive-TV or cable or satellite box (converter) comprises enlarged keys and/or color-coding according to function group. The enlarged keys provide a wider top surface and area between the keys, making the present invention easy for the use of children and infants.

### CROSS REFERENCE TO RELATED CASES

This application claims the benefit of U.S. Provisional Application Ser. No. 60/715,183, filed Sep. 9, 2005, which is incorporated by reference herein in its entirety.

### BACKGROUND

1. Technical Field

The present invention generally relates to a remote control for a television (TV) or TV converter more specifically, to an improved child's remote control.

2. Background of the Technology

Many young children begin using the TV while preliterate and unfamiliar with the conventional remote control configuration or unable to interpret the symbolic representations used on the remote control. The conventional remote control designed for adults is not properly or specifically designed for the young user and may in fact discourage, delay, or obstruct the child's interest in using the TV as a learning tool. Because of the size of the keys, the monochromatic color scheme, and the small characters on the conventional remote controls, children and infants may have great difficulties in making their intended keystroke on a conventional remote control.

### SUMMARY OF THE INVENTION

The present invention accordingly provides a remote control for use by young children, particularly children one to four years old. The remote control of the invention allows young children to play interactive games with TV or use interactive TV as a learning tool. Of course, the remote control of the invention similarly can be used by any preliterate person or person having underdeveloped or impaired motor skills.

According to a first embodiment, some or all the keys on a TV remote control have an enlarged top surface and/or greater area between keys than found on a standard TV remote control. For instance, the top surface of the key may be at least about 1 cm from side to side, and the area of the entire key, including the top surface, may be at least about 1.2 cm from side to side. In one embodiment, the key is about 2 cm from side to side, and the area of the entire key, including the top surface, may be about 2.5 cm from side to side. The keys alternatively or additionally may be separated on the remote control by at least about 0.5 cm. The characters on the keys may be enlarged proportionally to the increased key size. In one embodiment, the characters are iconic characters, where the icon corresponds to the function of the key.

According to second embodiment, the remote control provides keys that are color-coded according to function group for easy use by children. The characters may be coordinated with the function provided by the key. For example, the character may be in the form of an icon representing the function of the key. Function groups include, but are not limited to, programming the manner in which content on the TV is viewed and changing the programming based on input from the remote control.

### DETAILED DESCRIPTION

The present invention provides an improved remote control that allows young children to play interactive games with TV or use the interactive TV as a learning tool. The remote control according to the invention provides enlarged keys and/or enlarged space between the keys to facilitate error-free use of the remote control by young children or people with similarly underdeveloped or otherwise impaired motor skills. The remote control may further provide keys that are color-coded according to function group for easy use by children or other preliterate persons. The characters on the keys also may be enlarged and may be iconic characters that represent the function of the keys. For example, a key controlling fast forwarding of TV programming may have a rabbit as an icon.

A key having an enlarged top surface may be at least about 1 cm from side to side. For example, the key may be about 2 cm from side to side. Optionally, the surface of the key may be raised above the body of the remote control. In this embodiment, the base of the key may have a larger dimension than the top surface. In the example of a key having a top surface of about 2 cm, the base of the key may be 2.5 cm from side to side. Some or all of the keys may be spaced apart by a distance of about 0.5 cm, which advantageously minimizes the chance that the child or operator with underdeveloped motor skills will hit the wrong key.

The remote control is used for interactive TV independently of a keyboard (e.g., a keyboard having a QWERTY format), mouse or monitor required to control a personal computer. “Interactive TV” refers herein either to programming that the viewer can alter via the remote control or to programming in which the viewer can return information to the broadcaster. The latter ability is accomplished through a “return path” or “back channel” by telephone, mobile SMS (text messages), cable, or the like, according to means well known in the art. For instance, cable viewers receive their programs via a cable, and they generally use the same cable as a return path. Satellite viewers generally return information to the broadcaster via their regular telephone lines.

Some or all the keys of the present remote may be color-coded by function group. Color coded keys alternatively or additionally may have a top surface that is enlarged relative to the keys of a standard or conventional TV remote control, according to the embodiments described above. One of the function groups on the remote control allows the child to change the way particular programming content on the TV is viewed. For example, the function group allows the child to change TV channels, pause, rewind, and fast forward programming, skip commercials, and the like. The remote control can be set to control the content of the programming according to parental prerogatives by means known in the art.

Another function group on the remote control allows the child to change the program itself, based on input from the child through the remote control. For instance, keys on the remote control may allow the viewer to select from various endings (e.g. happy or sad) or plots of the stories. Keys also may allow the child to provide responses to the show, such as yes/no polling in response to questions posed in the programming or proposed answers to questions provided in the programming.

Interactivity is supplied by the manipulation of the application programming interface (API) of the particular software installed on a set-top box, referred to as “middleware” due to its intermediary position in the operating environment. Suitable software for interactivity is known in the art.

While the foregoing specification teaches the principles of the present invention, with examples provided for the purpose of illustration, it will be appreciated by one skilled in the art from reading this disclosure that various changes in form and detail can be made without departing from the true scope of the invention.

What is claimed is:

1. A child's television (TV) remote control comprising keys with an enlarged top surface and base relative to a standard TV remote control.

2. The remote control of claim 1, where the top surface is at least about 1 cm from side to side.

3. The TV remote control of claim 2, where the keys have a top surface about 2 cm from side to side.

4. The TV remote control of claim 1, where keys are separated by about 0.5 cm.

5. The TV remote control of claim 1, where the keys are raised above the body of the remote control.

6. The TV remote control of claim 5, where the base of the keys is wider then the top surface.

7. The TV remote control of claim 1, where a key comprises a character on the top surface of the key, where the character is about the same size as the top surface.

8. The TV remote control of claim 7, where the character is an iconic character that corresponds to the function of the key.

9. The TV remote control of claim 1, having keys that are color coded according to function group.

10. The TV remote control of claim 9, where the function group corresponds to programming the manner in which content on the TV is viewed.

11. The TV remote control of claim 9, where the function group corresponds to changing the programming based on input from the remote control.

12. A TV remote control, comprising keys that are color coded according to function group, where the function group corresponds to programming the manner in which content on the TV is viewed or changing the programming based on input from the remote control.

13. A method of using a television (TV) remote control, comprising operating a TV with the remote control, where the operator is a child and the remote control comprises keys having an enlarged top surface relative to a standard TV remote control and color coded according to function group.
